(19) United States
(12) Patent Application Publication
(10) Pub. No.: US 2010/0072715 A1
(43) Pub. Date: Mar. 25, 2010

(54) ELECTRONIC DEVICE FOR SHOPPING CART

(75) Inventor: Bryan Crum, Louisville, KY (US)

Correspondence Address: CAMORIANO & ASSOCIATES, 8225 SHELBYVILLE ROAD, LOUISVILLE, KY, 40222, US

(73) Assignee: Engage In-Store, LLC, Louisville, KY (US)

(21) Appl. No.: 12/561,674

(22) Filed: Sep. 17, 2009

Related U.S. Application Data
(60) Provisional application No. 61/171,165, filed on Apr. 21, 2009.
(60) Provisional application No. 61/098,465, filed on Sep. 19, 2008.

(51) Int. Cl. B62B 3/14

(52) U.S. Cl. 280/33.992

(57) ABSTRACT

An electronic display is mounted on a base which in turn is mounted on a shopping cart.

This application claims priority from U.S. Provisional Application Ser. No. 61/171,165 filed Apr. 21, 2009, and from U.S. Provisional Application Ser. No. 61/098,465, filed Sep. 19, 2008, both of which are hereby incorporated herein by reference.

### BACKGROUND

The present invention relates to shopping carts, and, in particular, to an arrangement for mounting both print information and electronic video information on a shopping cart to assist the shopper.

It is known to provide printed advertising materials on a shopping cart, and it is known to provide electronic video information on a shopping cart. Each type of display has advantages and disadvantages. Print information is relatively inexpensive to display, and it can be made weatherproof, so it can remain on the shopping cart at all times, even when the cart is outdoors. Such information may include a store map to help shoppers find products in the store, advertising materials, coupons, and so forth. Electronic video information can be more entertaining and engaging, including movies to entertain children while shopping, how-to videos to teach the shopper how to use products that are sold in the store, and so forth. However, the devices for displaying electronic video information are expensive and generally not weatherproof, so it is not desirable to allow them to leave the interior of the store.

### SUMMARY

One embodiment of the present invention takes advantage of the benefits of both print displays and electronic video displays on a shopping cart in a very practical and economical manner. It includes a base unit, which is secured to the handle of a cart and has a planar backplate and a planar body including printed matter mounted on the backplate. It also includes a separate, battery-operated electronic device with a video screen which mounts over the base unit. This enables the store owner to provide inexpensive print information to all customers on all the carts at all times while also providing the opportunity to present electronic video information to the customer by means of units that can be checked out by the customer for use while in the store. It also permits both the print materials and the electronic video to be displayed on the same prime location on the cart, which is most accessible and visible to the shopper.

### BRIEF DESCRIPTION OF THE DRAWINGS

FIG. 1 is a perspective view of a base unit with print advertising and a coupon pack mounted on a shopping cart;

FIG. 2 is an enlarged view of the base unit of FIG. 1 with the print advertising and coupon pack removed;

FIG. 3 is a bottom view of the base unit of FIG. 1;

FIG. 4 is a perspective view of an electronic unit being mounted on top of the base unit of FIG. 1;

FIG. 5 is a side view of the electronic unit and base unit of FIG. 4 before they are assembled together;

FIG. 6 is a side view of the electronic unit and base unit of FIG. 5 in a first stage of mounting the electronic unit onto the base unit;

FIG. 7 is a side view of the electronic unit and base unit of FIG. 6 with the electronic unit fully mounted onto the base unit;

FIG. 8 is a side view of the electronic unit of FIGS. 4-7;

FIG. 9 is a top perspective view of the frame of the electronic unit of FIGS. 4-7;

FIG. 10 is a bottom perspective view of the frame of the electronic unit of FIGS. 4-7;

FIG. 11 is a section view along line 11-11 of FIG. 9; and

FIG. 12 is a perspective view of a charging station for storing and charging the electronic units of FIG. 4.

### DESCRIPTION

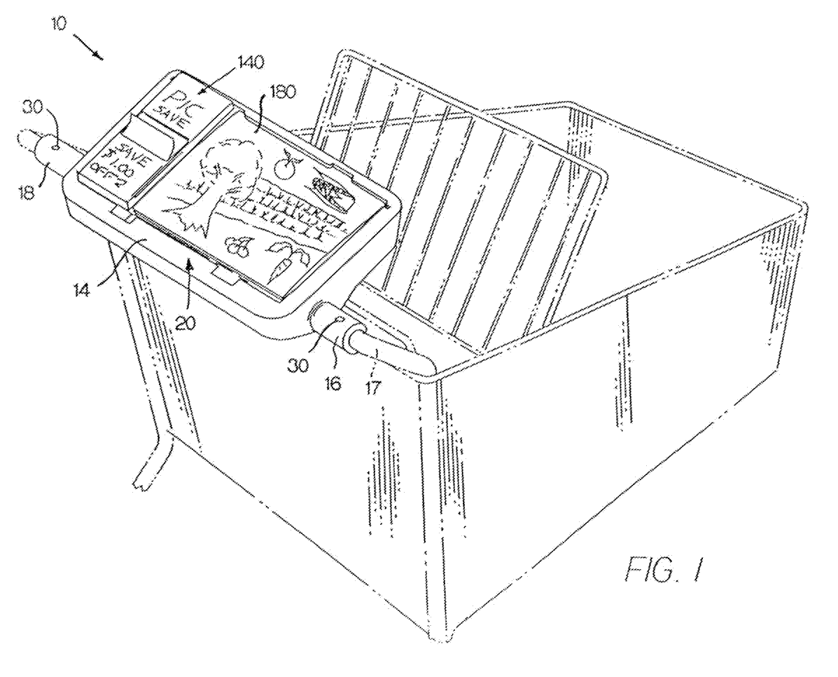

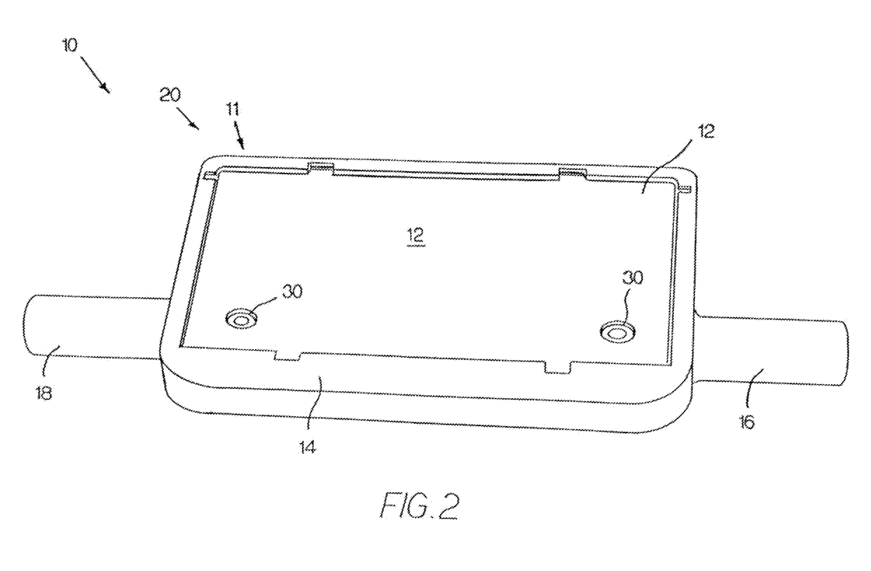

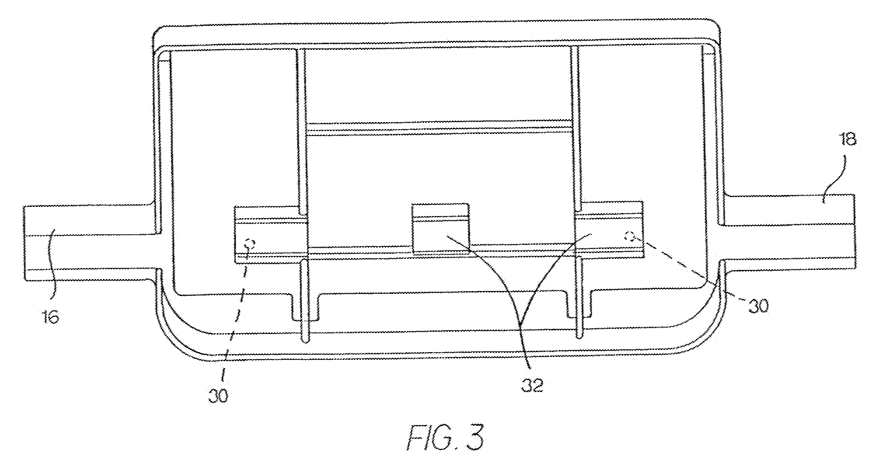

FIG. 1 shows a base unit 10, which is mounted on the handle of a shopping cart. This base unit has been described in detail in U.S. Patent Application US2008010873, which is hereby incorporated herein by reference. FIGS. 2 and 3 show more details of the base unit.

The base unit 10 includes a main body 11 which defines a central display area 20, including a backplate 12 and raised frame 14 surrounding the backplate 12, and a right handle 16 and left handle 18 rigidly attached to and projecting outwardly from the main body 11. In this embodiment, the base unit 10 is molded as single unit. In FIG. 1, the base unit 10 is holding a coupon dispenser 140 and a magazine 180. The front, rear and left side edges of the coupon dispenser 140 are received under a lip on the raised frame 14. Similarly, the rear edge of the magazine, which includes the spine, is received under a lip on the raised frame 14, while the left, right and front edges of the pages of the magazine are free to open completely without interference from the raised frame 14. The back cover of the magazine 180 is a card, which is bound with the spine on the rear edge and extends beyond the pages and is received under the lip of the raised frame 14 on its right and front edges. The card portion of the magazine 180 is adhered to the backplate 12 as is the bottom of the coupon dispenser 140.

The magazine 180 includes print advertising, and the front surface of the card, which forms the back cover of the magazine, includes a map of the store.

In another embodiment, only the card displaying the store map may be used, with no additional pages.

The planar backplate 12 of the base unit 10 lies at an angle of about twenty degrees from the horizontal, so it is readily visible to the shopper pushing the cart. It is preferred that the angle be between ten degrees and sixty degrees and more preferred that it be between fifteen degrees and thirty degrees.

The handle portions 16, 18 of the base unit 10 are open on the bottom, providing a C-shaped cross-section so they can be snapped over the shopping cart handle. Platforms 32 extend from the bottom of the base unit 10 and provide additional support on the handlebar 17 of the shopping cart. Each platform 32 has a concave arcuate bottom surface, which allows it to wrap partially around the handlebar 17 of the cart.

This base unit 10 preferably is secured to the shopping cart handle by means of screws extending through holes 30, so it remains with the cart. The base unit 10, along with the print materials attached to it, provides information to the shopper, such as a store map, a store directory, information about specials, coupons, and so forth.

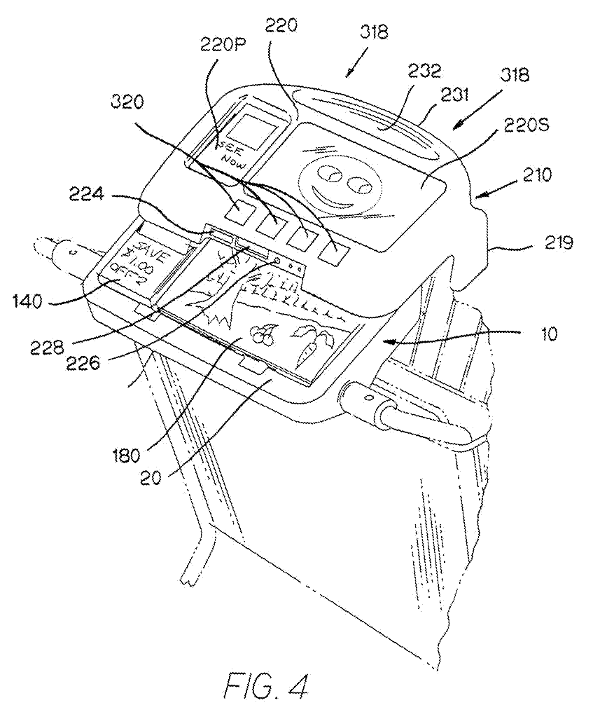

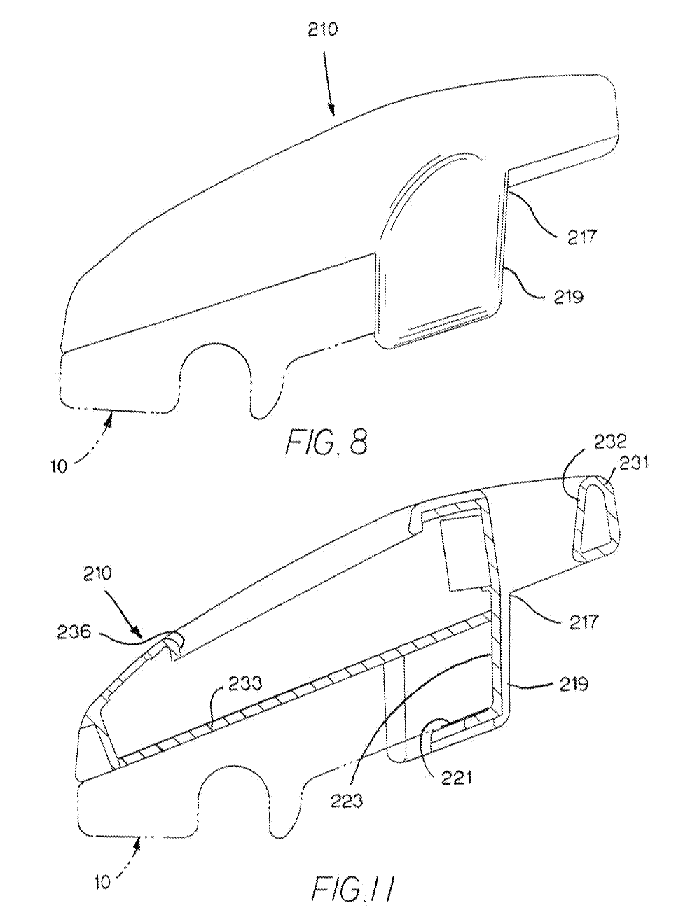

FIGS. 4-8 and 11 show an electronic unit 210 including a planar electronic video display 220S being mounted on top of the base unit 10. The display area 220 of the electronic unit 210 is generally planar and covers over the flat backplate 12 and display area 20 of the base unit 10, including covering over the coupon dispenser 140 and magazine 180 (or card) mounted on the backplate 12. The display area 220 includes an electronic video screen 220S and a place for printed matter 220P, but the video screen 220S could encompass the entire display area 220, if desired.

The electronic video screen 220S of the electronic unit 210 is substantially flat or planar, and, as shown in FIG. 11, it lies substantially parallel to the planar backplate 12 of the base unit. It is preferred that the plane of the electronic video screen be within twenty degrees of the plane of the backplate 12 of the base unit.

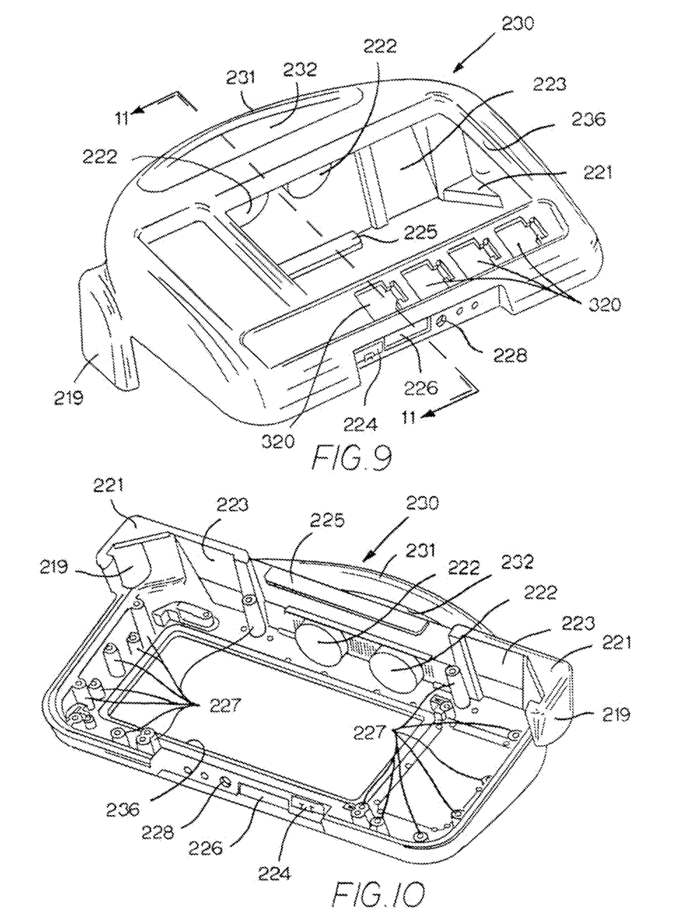

In this embodiment, the display 220S is a touch screen, so the shopper can interact with the electronic unit 210 by pressing the touch screen 220S at various locations as indicated on the screen. Alternatively, or in addition to the touch screen 220S, the electronic unit 210 may have buttons 320 or scroll wheels, or other known input mechanisms (not shown). The electronic unit 210 may include the features and functionality of a laptop, a cell phone, an MP3 player, a GPS unit, and/or other similar electronic products, as desired, in addition to having the ability to play electronic videos on the screen 220S and to provide audio output through speakers 222 (See FIGS. 9 and 10).

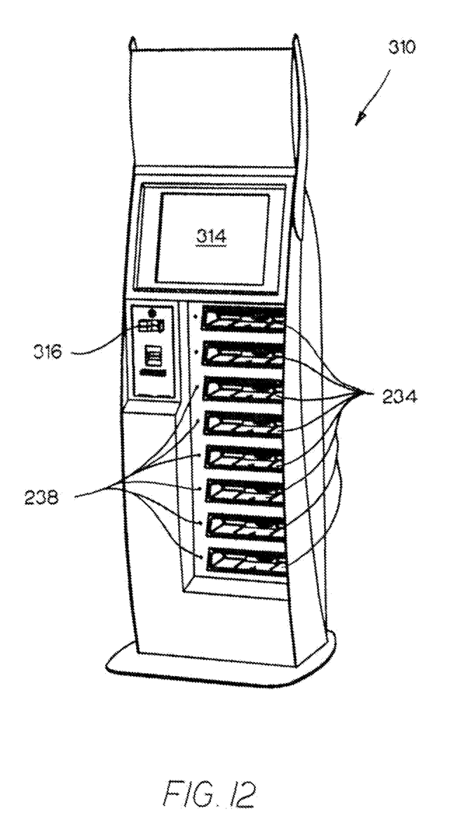

It also may have a wide variety of interconnectivity options, if desired, such as BlueTooth, WiFi, a receiver for receiving global positioning information from a satellite GPS, a receiver for receiving streaming video, a transmitter, and so forth. The electronic unit 210 also includes switches 224 (for on/off function of the device, for instance), terminals 226 (for head phone jacks, for instance), and electrical connectors 228 (for USB/power input adapters, for instance) that allow it to be connected to a docking station 310 (See FIG. 12) for charging the battery on the electronic unit 210 and for transmitting data to the electronic unit, as explained in more detail later.

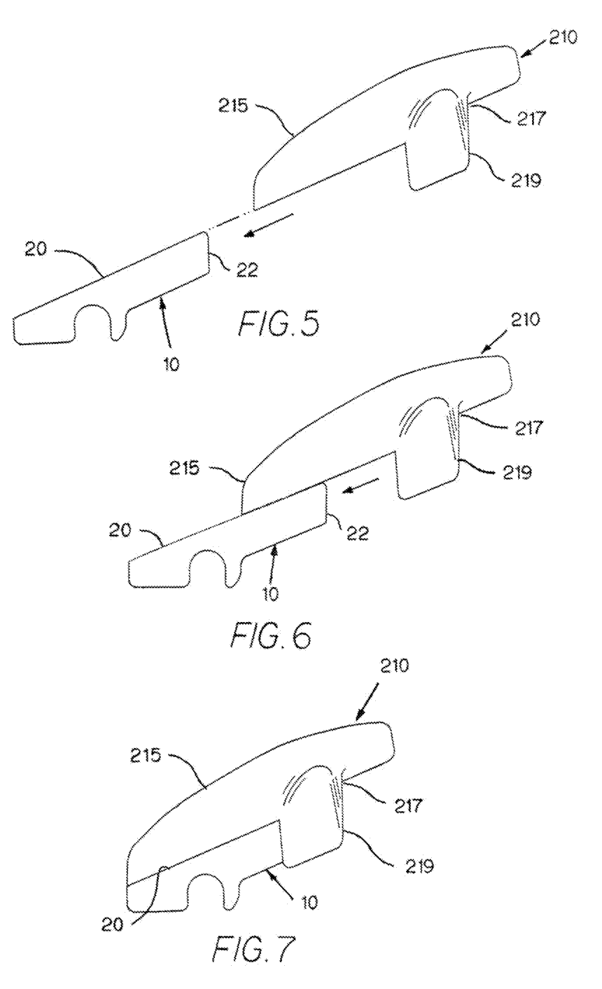

As shown in FIGS. 5-7, the electronic unit 210 slides over the base unit 10 to be assembled onto the base 10. When the electronic unit 210 is assembled onto the base, the main body portion 215 of the electronic unit 210 rests on top of the base unit 10, and downwardly-extending projections 219 forming the rear portion 217 of the electronic unit 210 receive and wrap around the rear portion 22 of the base unit 10, so the electronic unit 210 is held on the base unit 10 by gravity. The downwardly-extending projections (or flaps) 219 include bottom platforms 221 (See FIGS. 9, 10, and 11) extending to the rear wall 223 of the electronic unit 210. A bottom tab 225 also projects forwardly from the central portion of the rear wall 223. In conjunction with the force of gravity, these bottom platforms 221 and bottom tab 225 latch onto the bottom edge of the base unit 10, toward the rear 22 of the base unit 10, to hold the electronic unit 210 onto the base unit 10.

The main frame 230 of the electronic unit 210 is preferably made from a single molded plastic piece (See FIGS. 9 and 10) onto which is secured a simple, flat plastic bottom enclosure 231. It includes a plurality of bosses 227 for receiving screws (not shown) to secure the various electronic components (such as the electronic screen 220, an integrated circuit board (not shown), a rechargeable battery (not shown), and speakers 222). The frame 230 preferably includes a rubber overmold, made of a softer, more shock absorbent material than the frame 230, which completely covers its surface to provide additional protection of the device 210 in the event it is accidentally dropped or bumped. The electronic screen 220S (See FIG. 4) is received in the rectangular opening 236 (See FIGS. 9, 10, and 11) and is recessed from the top surface of the frame 230. It may be appreciated that the flat surface of the electronic screen 220S is substantially parallel to the flat display area 20 of the base unit 10 when the electronic unit 210 is mounted onto the base unit 10.

In order to assemble the electronic unit 210 onto the base 10, the electronic unit 210 is slid forwardly, in the direction of the arrows 318 in FIG. 4, so that the rear 22 of the base unit 10 is received in the receptacles formed between the rear wall 223 and the platforms 221 and the support tabs 225. When the electronic unit 220 is all the way forward (as shown in FIG. 7), the rear wall 223 of the electronic unit 210 abuts the rear wall 22 of the base unit 10. Due to the angle of the base unit 10, the electronic unit 210 is secured onto the base 10 by gravity. Once the electronic unit 210 is mounted onto the base unit 10, covering the print materials on the base unit 10, the electronic unit 210 and base unit 10 function as a single unit, securely supporting the electronic unit 210 on the shopping cart handle.

The electronic unit 210 includes a handle 231, which defines a large through opening 232 (See FIGS. 9, 10, and 11) that allows a person's fingers to extend through in order to grasp the handle 231. This handle 231 is particularly useful for pulling the unit 210 out of the docking station 310 as described below.

FIG. 12 shows a docking station 310, which stores and charges the electronic units 210. The docking station 310 provides a plurality of parallel, horizontally-oriented, vertically stacked slotted openings (or shelves) 234 to support the electronic units 210. Each of these shelves 234 provides rigid electrical connectors at the rear which plug into receptacles 228 (See FIGS. 4 and 9) in the electronic units 210 when they are slid into the docking station 310. These connections are used to charge the batteries (not shown) in the electronic units 210 and to transmit data to and from the on-board memory of the electronic units 210. Of course, data may be transmitted to and from the electronic units by wireless means instead of or in addition to using the connectors at the docking station, if desired.

It is preferred that the electronic units 210 not leave the store, so the docking station 310 is located inside the store, and the store has a detector near the doorways to detect the electronic units 210 and sets off an alarm to prevent an electronic unit 210 from passing out the door. The electronic unit 210 may include a “smart chip” or other transmitter that triggers the detector near the doorway. It also may transmit to and receive from stations at various locations within the store, in order to provide information to the shopper as he proceeds through the store. For example, if the shopper is going through the paint aisle in the store, the electronic unit may communicate with a transmitter in that aisle, which will initiate a short video clip on the electronic unit 210 telling the shopper about specials in that aisle or displaying a video showing how to paint a room, and so forth.

A shopper generally will pick up a shopping cart either outside the store or inside the store, with the base unit 10 and its print materials (card, coupon pack, and/or magazine) mounted on the cart. Once inside the store, if the shopper wants to use an electronic unit 210, he may go to the docking station 310, pull out an electronic unit 210, and mount it onto the base unit 10 on his cart covering over the print materials. He then uses the electronic unit 210 as he goes through the store. He may touch the screen and follow menus to find out where products are located in the store, to locate specials in the store, to view videos about products in the store, such as how they are used, and so forth.

If desired, the electronic unit 210 may also include a bar code scanner so the shopper can scan products to see their prices or to perform a self-check-out as he shops.

As the shopper finishes shopping and goes to the front of the store, usually to check out and pay for the items he is purchasing, he will remove the electronic unit 210 from the base 10. He may then give it to a cashier, leave it in a bin, insert it into a docking station 310, or otherwise surrender it before leaving the store. The electronic unit 210 will be returned to the docking station 310, where it will then be ready for use by the next shopper.

The docking station 310 includes a touch screen 314 and a card swipe reader 316, which allows the shopper to swipe a credit card or a frequent shopper card, which identifies the shopper's account. This may be used to enable the shopper to rent the electronic unit as well as to rent a video that can be played on the electronic unit while shopping. The electronic unit 210 may already be storing one or more digital videos on its on-board memory, or one or more videos may be downloaded from the docking station 310 to the electronic unit 210 when selected by the shopper. The shopper uses the touch screen 314 to select which video he wants to rent, swipes a credit card, gift card, or other card containing electronic information through the card swipe reader 316, and the docking station 310 causes an indicator light 238 to light up to tell the shopper which electronic unit 210 to remove from the docking station 310.

This arrangement may store information about the shopper, so when the shopper inputs an identification number or is identified by swiping the card or by other means (such as a customer loyalty card), he may be awarded a free movie rental based on his shopping history or may be reminded that, after renting an additional specified number of movies or spending an additional specified amount of money in the store, he will be eligible for a free movie rental. This can be used to help build customer loyalty.

The shopper then removes the electronic unit 210 from the docking station 310 and slides it onto the base unit 10 on his cart, sliding in the direction shown by the arrows 318 in FIG. 4. The electronic unit 210 wraps around and overlies the top surface of the base unit 10, covering over the print material on the display area of the base unit 10.

As shown in FIG. 4, the video screen 220S is playing the video that has been rented. This is not a touch screen, but it does have a plurality of buttons 320, which can be used to start and stop the video, increase and decrease the volume, and rotate the electronic image 180 degrees to invert the orientation of the image so it will be properly oriented for a child riding in the seat on the cart. In this manner, the electronic image may be oriented in the usual manner to be viewed by the person pushing the cart or for a person walking alongside the cart, and, with the push of a button 320, the image may be inverted for viewing by a person inside the cart. The orientation may be changed back and forth just by pushing the appropriate button 320, which is dedicated to that function. Of course, if a touch screen is used, the buttons may be within the screen itself. In either case, whether it is a separate physical button 320 or a button within a touch screen, it is preferred that there be a dedicated input that permits the user to invert the image with just one touch.

When the shopper has finished shopping, he removes the electronic unit 210 from the cart and returns it to a docking station 310, where it is recharged and where another person may pick it up. The returning of the unit 210 also may create a credit on the shopper's account as a reward for putting the electronic unit 210 back where it belongs.

It will be obvious to those skilled in the art that modifications may be made to the embodiments described above without departing from the scope of the present invention.

What is claimed is:

1. An arrangement for providing a display on a shopping cart, comprising:
a shopping cart including a handle;
a first body defining a display area, including a planar backplate, said body being mounted on the handle of the shopping cart;
a planar body displaying printed matter releasably mounted on said planar backplate; and
a second body including a planar electronic video display screen, said second body being releasably mounted on top of said first body and overlying at least a portion of said planar body.

2. An arrangement for providing a display on a shopping cart as recited in claim 1, wherein said planar video display screen is substantially parallel to said planar backplate.

3. An arrangement for providing a display on a shopping cart as recited in claim 2, wherein said planar video display screen lies on a plane that is within twenty degrees of said planar backplate.

4. An arrangement for providing a display on a shopping cart as recited in claim 3, wherein said second body completely covers said planar body;

5. An arrangement for providing a display on a shopping cart as recited in claim 3, wherein said planar body is a card adhered to the planar backplate.

6. An arrangement for providing a display on a shopping cart as recited in claim 3, wherein said planar body is a magazine adhered to the planar backplate.

7. An arrangement for providing a display on a shopping cart as recited in claim 3, wherein said planar body is a coupon pack.

8. An arrangement for providing a display on a shopping cart as recited in claim 1, wherein each of said first and second bodies has front and rear portions and the rear portion of said second body defines a receptacle that receives the rear portion of said first body.

9. An arrangement for providing a display on a shopping cart as recited in claim 8, wherein said second body further includes a dedicated input including means for selectively inverting the orientation of display of images on said screen.

10. An arrangement for providing a display on a shopping cart as recited in claim 9, wherein said second body defines a handle at the rear of said second body.

11. An arrangement for providing a display on a shopping cart as recited in claim 10, wherein said second body houses a rechargeable battery and wherein said front portion of said second body includes an electrical adapter for connecting said battery to a power source.

12. An arrangement for providing a display on a shopping cart as recited in claim 11, and further comprising a station defining a plurality of horizontally-oriented, vertically-stacked slotted openings, each of said openings including means for receiving at least one of said second bodies and for providing electrical connectivity between said second body and said station.

13. An arrangement for providing a display on a shopping cart as recited in claim 8, and further comprising a station defining a plurality of horizontally-oriented, vertically-stacked slotted openings, each of said openings including means for receiving at least one of said second bodies and for providing electrical connectivity between said second body and said station.

14. An arrangement for providing a display on a shopping cart as recited in claim 12, wherein said station includes means for electronically identifying an account for a user which allows the user to select desired content;
means for making the selected content available to at least one of said second bodies received in said station; and
means for charging said user account.

15. An arrangement for providing a display on a shopping cart as recited in claim 13, wherein said station includes means for electronically identifying an account for a user which allows the user to select desired content;
means for making the selected content available to at least one of said second bodies received in said station; and
means for charging said user account.

16. An arrangement for providing a display on a shopping cart, comprising:
a shopping cart including a handle;
a first body mounted on the handle of the shopping cart and defining a display area, including a planar backplate;
a planar body displaying printed matter releasably mounted on said planar backplate;
a second body including a planar electronic video display screen substantially parallel to said planar backplate, said second body being releasably mounted on top of said first body and covering said planar body;
wherein said second body defines front and rear portions; and a receptacle in said rear portion that receives said first body; said second body further comprising a dedicated input including means for selectively inverting the orientation of display of images on said screen, and a rechargeable battery; and wherein said front portion includes an electrical adapter for plugging said battery to a power source; and
a station defining a plurality of horizontally-oriented, vertically-stacked slotted openings, each of said openings suitable for receiving at least one of said second bodies to provide electrical connectivity between said second body and said station; wherein said station includes means for electronically identifying an account for a user; means for allowing the user to select desired content; means for making the selected content available on at least one of said second bodies; and means for charging said user account.
